(19) United States
(12) Patent Application Publication
(10) Pub. No.: US 2005/0241072 A1
(43) Pub. Date: Nov. 3, 2005

(54) Method of controlling water supply in washer

(75) Inventors: Jong Min Kim, Changwon-si (KR); Yang Hwan No, Changwon-si (KR); Han Ki Cho, Changwon-si (KR); Ho Sung Jang, Gyeongsangnam-do (KR); Dong Hoon Kang, Busan (KR); Jung Hoon Kang, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/103,512

(22) Filed: Apr. 12, 2005

(30) Foreign Application Priority Data
Apr. 14, 2004 (KR) P2004-25966

(51) Int. Cl. B08B 3/12; D06F 37/00

(52) U.S. Cl. 8/158; 68/17 R; 68/3 R; 68/12.01; 68/12.19; 68/207

(57) ABSTRACT

A method of controlling water supply in an automatic washer controls one or more water supply valves according to predetermined times for momentarily turning off the water supply valve until a predetermined water level is reached, to prevent flooding and a resulting contamination of a detergent box area and to control a mixing of agents with the supplied water. The automatic washer has at least one water supply valve for supplying the water to a tub via a detergent box and a water level detector for detecting a level of the water suppled to the tub. The method includes turning on the at least one water supply valve during a first predetermined time; and turning off, after elapse of the first predetermined time, the at least one water supply valve during a second predetermined time and further comprises repeating the above turning on and turning off until the level of the water supplied to the tub reaches a predetermined water level. The first predetermined time is proportional to a volume of the detergent box, and the second predetermined time is inversely proportional to the volume of the detergent box

This application claims the benefit of Korean Application No. 10-2004-0025965 filed on Apr. 14, 2004, which is/are hereby incorporated by reference.

### BACKGROUND OF THE INVENTION

1. Field of the Invention

The present invention relates to automatic washers, and more particularly, to an apparatus and method for controlling water supply in an automatic washer, in which one or more water supply valves are controlled according to predetermined times for momentarily turning off the water supply valve until a predetermined water level is reached.

2. Discussion of the Related Art

An automatic washer is an apparatus for cleaning laundry by receiving a controlled supply of water, typically from both hot and cold water sources, to be mixed with controlled quantities of detergents, bleach, softening agents, and the like. A general automatic washer, such as that shown in FIG. 1, essentially comprises a tub 10 for holding washing water; a cylindrical drum 20, which is perforated and rotatably provided within the tub, for receiving laundry; a water supply device 40 for supplying to the tub 10 water from an external source; and a detergent supply device 50 having internal compartments for storing detergent and other agents to be mixed with the supplied water via internal passages connected to the water supply device. The tub 10 and drum 20 are provided in an outer casing 2 on which the water supply device 40 and detergent supply device 50 are typically installed.

The water supply device 40 comprises a plurality of water supply valves 42a, 42b, 42c, and 42d variously connected to a pair of external hoses 41a and 41b, respectively connected to external water sources, for controlling the external supply of water; a plurality of water supply hoses 43a, 43b, 43c, and 43d respectively connecting the water supply valves to entrances of the detergent supply device 50; and a bellows tube 44, connected to the exit of the detergent supply device, for conveying washing water to the tub 10. Here, the washing water is water having passed through the detergent supply device 50 and being mixed with the detergent and other agents stored in the detergent supply device. The water supply valves include first, second, and third cold water valves 42a, 42b, and 42c and a hot water valve 42d, and the water supply hoses include first, second, and third cold water hoses 43a, 43b, and 43c and a hot water hose 43d.

The detergent supply device 50 comprises a detergent box housing 52 connected to the bellows tube 44, a detergent box 54 arranged within the detergent box housing and disposed adjacent a control panel 7, and a dispenser cover 70 provided above the detergent box housing and connected to each of the water supply hoses 43a, 43b, 43c, and 43d. Thus, the water from the external source is supplied via one or more of the water supply valves 42a, 42b, 42c, and 42d to enter the detergent box 54 through the dispenser cover 70 and to exit the detergent box through the detergent box housing 52, to be mixed with the stored agents and supplied as washing water to the tub 10 via the bellows tube 44.

Referring to FIG. 2, illustrating a water supply control method in a washer as described above, one of the water supply valves 42a, 42b, 42c, and 42d is turned on (S1) to thereby supply water (S2) to the detergent supply device 50. While the water supply valve is turned on, water is passed through the corresponding water supply hose and the level of washing water, exiting the detergent supply device 50 and filling the tub 10 via the bellows tube 44, is detected. The water supply continues until a predetermined level is reached (S3), whereupon the water supply valve is turned off (S4).

In the above-described method of the related art, however, the agents stored in the detergent supply device 50 may fail to be properly drained with the water, such as if an excessive amount of detergent is stored in the detergent supply device 50 or if the stored detergent blocks the internal passages of the detergent supply device, whereby washing water may overflow the detergent supply device and contaminate the area. In doing so, there is a further failure to control the quantity of agents being mixed with the water.

### SUMMARY OF THE INVENTION

Accordingly, the present invention is directed to a method of controlling water supply in an automatic washer that substantially obviates one or more of the problems due to limitations and disadvantages of the related art.

An object of the present invention, which has been devised to solve the foregoing problem, lies in providing a water supply control method, which prevents flooding and a resulting contamination of a detergent box area and controls a mixing of agents with the supplied water.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a method of supplying water in an automatic washer having at least one water supply valve for supplying the water to a tub via detergent box and a water level detector for detecting a level of the water suppled to the tub. The method comprises turning on the at least one water supply valve during a first predetermined time; and turning off, after elapse of the first predetermined time, the at least one water supply valve during a second predetermined time and further comprises repeating the above turning on and turning off until the level of the water supplied to the tub reaches a predetermined water level. The first predetermined time is proportional to a volume of the detergent box, and the second predetermined time is inversely proportional to the volume of the detergent box.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective diagram of a general automatic washer;

FIG. 2 is a flowchart of a water supply control method according to a related art;

FIG. 3 is an exploded perspective view of a water supply device and a detergent supply device of an automatic washer adopting a water supply control method of the present invention;

FIG. 4 is a plan view of the detergent supply device of FIG. 3;

FIG. 5 is a cross-sectional view cut along a line V-V in FIG. 4;

FIG. 6 is a cross-sectional view cut along a line VI-VI in FIG. 4;

FIG. 7 is a diagram of an automatic washer adopting a water supply control resent invention; and

FIG. 8 is a flowchart of a water supply control method according to the present invention.

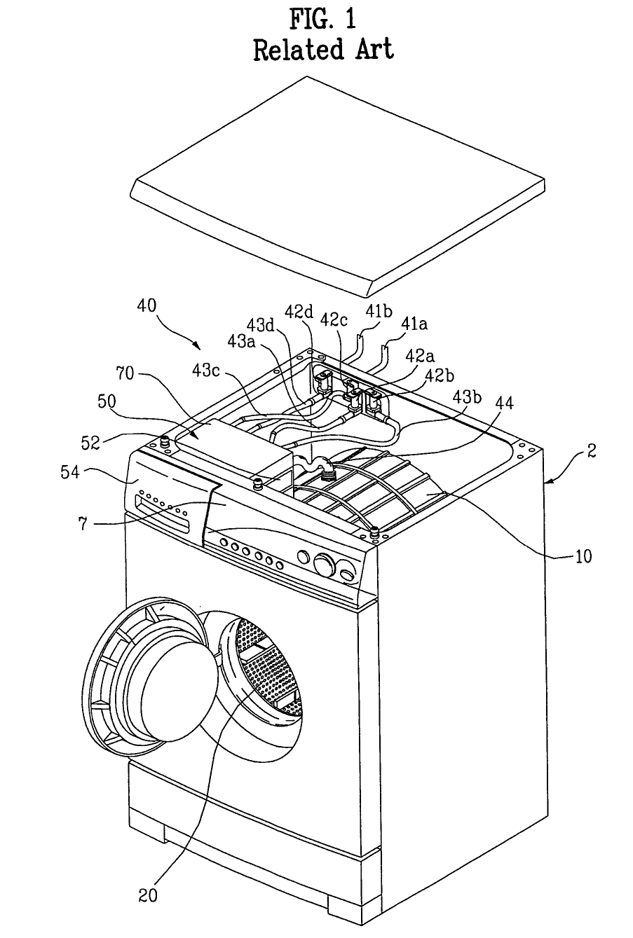

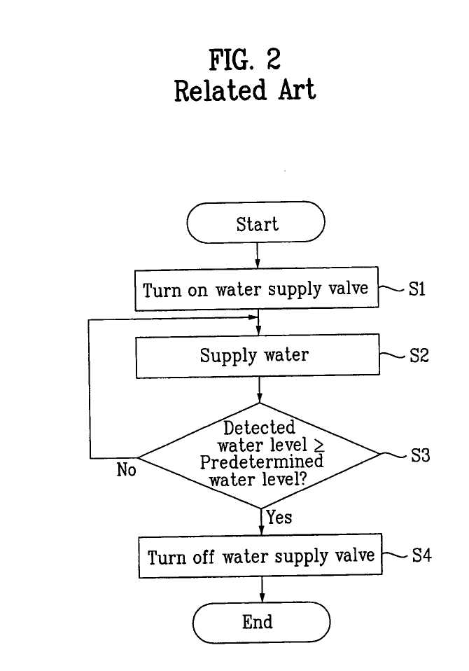

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

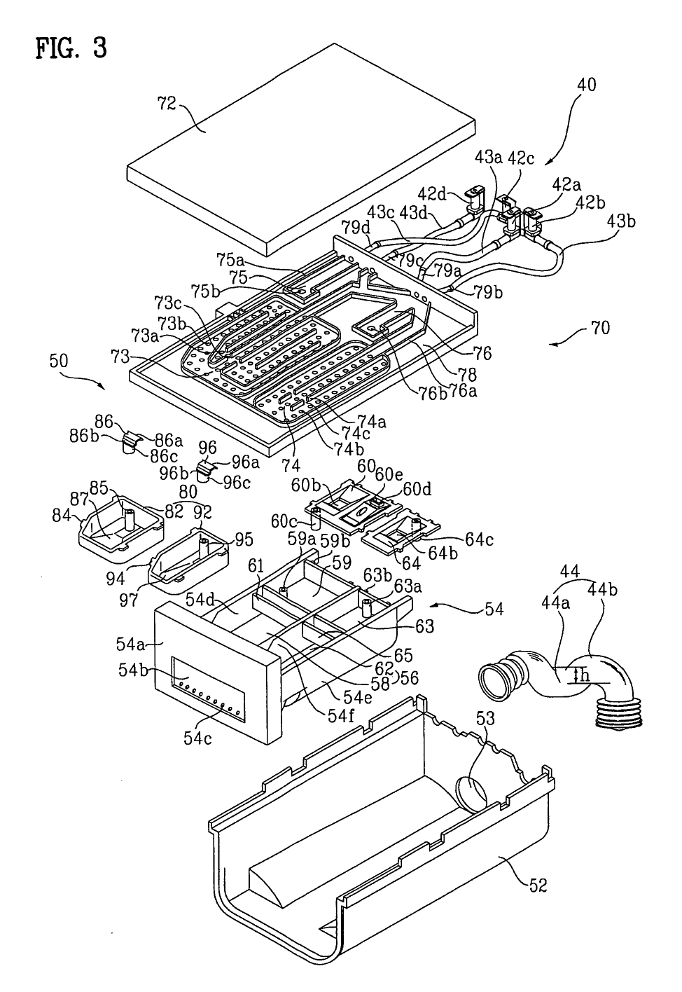

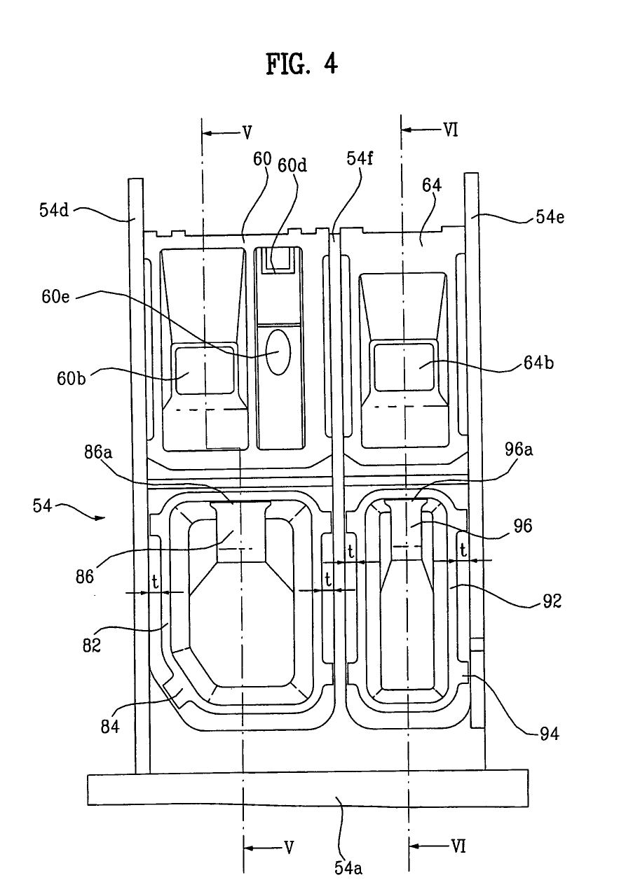

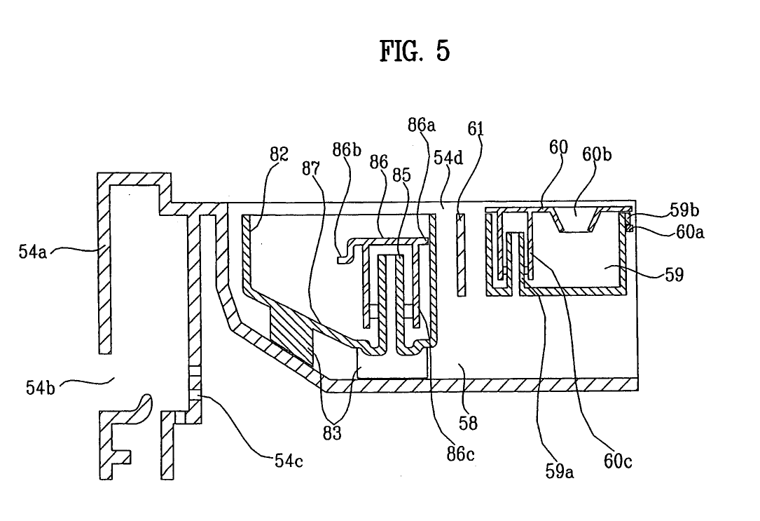

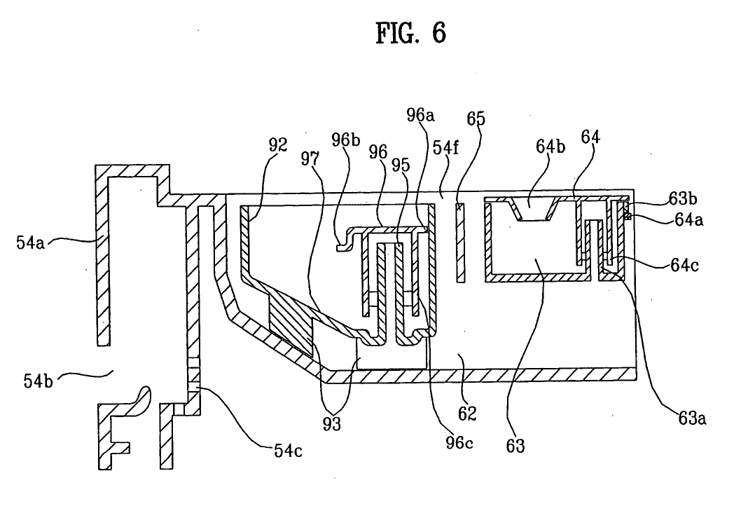

As shown in FIGS. 3-6, an automatic washer adopting the water supply control method of the present invention includes a water supply device 40 and a detergent supply device 50.

The water supply device 40 comprises of a plurality of water supply valves 42a, 42b, 42c, and 42d for controlling the supply of water from an external source, including cold water and hot water, a plurality of water supply hoses 43a, 43b, 43c, and 43d respectively leading the water having passed through the water supply valves to the detergent supply device 50, and a bellows tube 44 leading the water having passed through the detergent supply device to a tub. The bellows tube 44, which includes an air trap composed of a first bend 44a extended downward and connected to a second bend 44b extending above the first bend by a height h, is configured to allow upstream air to move to the tub 10 and to allow steam flowing backward from the tub to be condensed into the water remaining in the first bend of the bellows tube.

The detergent supply device 50 comprises a detergent box 54 detachably provided within the detergent box housing 52, which has an open front and top and is connected at a low point to the bellows tube 44 and covered by a dispenser cover 70 selectively receiving water via the water supply hoses 43a, 43b, 43c, and 43d to be supplied (drained) to the detergent box disposed below via its open top. A liquid detergent receptacle 80 for mixing a liquid detergent with the water supplied to the detergent box 54 is detachably provided (loadable) to the detergent box. Washing water exits the detergent box housing 52 at an outlet 53 for receiving the bellows tube 44.

The detergent box 54 comprises a powder detergent compartment 56 for storing a powder detergent to be mixed with water and a front 54a, coupled to a forward end of the powder detergent compartment and provided with a grip 54b where ventilation holes 54c are formed to introduce air into an interior of the detergent box housing 52. The powder detergent compartment 56 includes sidewalls 54d and 54e and is partitioned by a partition 54f into a main detergent compartment 58 and a preliminary detergent compartment 62. Respectively disposed on either side of the upper rear of the detergent box 54, a bleach compartment 59 for storing bleach is integrally formed with the main detergent compartment 58 and a softening agent compartment 63 for storing a softening agent is integrally formed with the preliminary detergent compartment 62. The main detergent compartment 58 includes a main detergent blocking rib 61 for preventing detergent from clogging the bleach compartment 59, and the preliminary detergent compartment 62 includes a preliminary detergent blocking rib 65 for preventing detergent from clogging the softening agent compartment 63.

The bleach compartment 59 includes an inner bleach siphon tube 59a extending upward from a bottom wall spaced apart from an inner bottom surface of the main detergent compartment 58 and has an open top covered by a bleach siphon cover 60, which has an outer bleach siphon tube 60c extending downward to receive the inner bleach siphon tube and form a drain passage from a bleach inlet 60b to the bleach compartment below. One end of the bleach siphon cover 60 has a recess 60a for receiving a hook 59b provided to the bleach compartment 59. A top surface of the bleach siphon cover 60 has a catch 60d protruding upward to be caught on the control panel 7 or the dispenser cover 70 when pulling the detergent box 54 forward and an elastic release 60e for, when pushed, lowering the protruding height of the catch and thereby releasing its catching function.

The softening agent compartment 63 includes an inner softening agent siphon tube 63a extending upward from a bottom wall spaced apart from an inner bottom surface of the preliminary detergent compartment 62 and has an open top covered by a softening agent siphon cover 64, which has an outer softening agent siphon tube 64c extending downward to receive the inner softening agent siphon tube and form a drain passage from a softening agent inlet 64b to the softening agent compartment below. One end of the softening agent siphon cover 64 has a recess 64a for receiving a hook 63b provided to the softening agent compartment 63.

The dispenser cover 70 includes a top panel 72 and a bottom panel 78 to form a main detergent water supply passage 73, a preliminary detergent water supply passage 74, a bleach water supply passage 75, and a softening agent water supply passage 76. The bottom panel 78 of the dispenser cover 70 is provided with a main detergent water supply rib 73a forming the main detergent water supply passage 73, a preliminary detergent water supply rib 74a forming the preliminary detergent water supply passage 74, a bleach water supply rib 75a forming the bleach water supply passage 75, and a softening agent water supply rib 76a forming the softening agent water supply passage 76. A multitude of main detergent water supply holes 73b and preliminary detergent water supply holes 74b are formed in the bottom panel 78 to be disposed over forward portions of the main detergent and preliminary detergent compartments 58 and 62, respectively, and a bleach water supply hole 75b and a softening agent water supply hole 76b are formed in the bottom panel to be disposed over the bleach and softening agent compartments 59 and 63, respectively. A plurality of bypass openings 73c and 74c are formed in the main detergent water supply rib 73a and in the preliminary detergent water supply rib 74a, respectively, to allow water passing through the main detergent water supply passage 73 and through the preliminary detergent water supply passage 74 to be directly drained via the main detergent water supply holes 73b and the preliminary detergent water supply holes 74b. The top and bottom panels 72 and 78 are assembled to each other by thermal fusion. The bottom panel 78 of the dispenser cover 70 is provided with first to fourth hose connectors 79a, 79b, 79c, and 79d, which are respectively connected to the first to third cold water hoses 43a, 43b, and 43c and the hot water hose 43d, such that the first and second cold water hoses and the hot water hose can selectively supply cold or hot water to each of the main detergent water supply passage 73, the preliminary detergent water supply passage 74, and the softening agent water supply passage 76 and such that the third cold water hose can selectively supply cold water to the bleach water supply passage 75.

The liquid detergent receptacle 80 includes a first liquid detergent receptacle 82 detachably provided to the main detergent compartment 58 and a second liquid detergent receptacle 92 detachably provided to the preliminary detergent compartment 62 but may include just one of the first and second liquid detergent receptacles. Each of the first and second liquid detergent receptacles 82 and 92 is loaded in a forward portion of the main detergent compartment 58, and when loaded, its upper end is disposed lower than an upper end of the main detergent compartment. The first and second liquid detergent receptacles 82 and 92 include a plurality of first bottom protrusions 83 and a plurality of second bottom protrusions 93, respectively, to be seated on an inner bottom surface of the powder detergent compartment 56, while leaving a predetermined space between an outer bottom surface of the corresponding liquid detergent receptacle and the inner bottom surface the powder detergent compartment. Each of the first and second liquid detergent receptacles 82 and 92 is narrower than a horizontal distance between the sidewalls 54d and 54f or between the sidewalls 54f and 54e, such that a gap t exists between each sidewall and one side of the first and second liquid detergent receptacles, which are supported by a plurality of side protrusions 84 and 94 extending laterally from the sides of the first and second liquid detergent receptacles, so that any overflow of either the first or second liquid detergent receptacle is drained via the gap t, without entering adjacent areas. The first and second liquid detergent receptacles 82 and 92 have open tops and include first and second inner liquid detergent siphon tubes 85 and 95 extending upward from a bottom wall connected to a sloped wall 87 or 97 and first and second liquid detergent siphon covers 86 and 96, each of which has an outer liquid detergent siphon tube 86c or 96c extending downward to receive the inner liquid detergent siphon tubes and form a drain passage from the open tops to the powder detergent compartment 56 below. The first and second liquid detergent siphon covers 86 and 96 are respectively provided with flat tops 86a and 96a, hanging on a sidewall of the first or second liquid detergent receptacle and thereby inhibiting a rotational movement, and liquid quantity viewing means 86b and 96b for providing a visual representation of an upper limit of the liquid detergent.

Referring to FIG. 7, a control portion of an automatic washer adopting a water supply control method of the present invention comprises a water level detector 98 for detecting a water level within the tub and a controller 99 for individually controlling the water supply valves 42a, 42b, 42c, and 42d to intermittently supply the water via the water supply valves on water supply and to end the water supply by terminating the on/off control of the water supply valves when the water level detected by the water level detector 98 reaches a predetermined level.

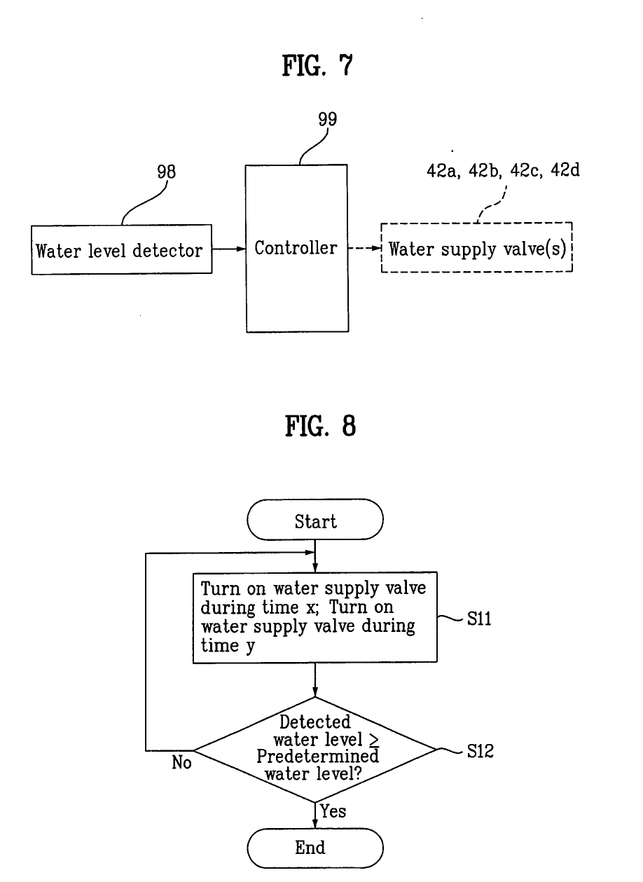

Referring to FIG. 8, illustrating a water supply control method according to the present invention, at least one of the water supply valves 42a, 42b, 42c, and 42d is turned on for a first predetermined time x and is then turned off for a second predetermined time y (S11). The value of each predetermined time is set according to the configuration of the detergent box 54, and in particular, according to the configuration of a corresponding compartment of the detergent box, including one or more of compartments 58, 59, 62, 63, 80, and 92, with the first predetermined time x being preferably set up in proportion to the respective volumes of the compartments and the second predetermined time y being preferably set up in inverse proportion to the respective volumes of the compartments. While the water supply valve is turned on, i.e., during the first predetermined time x, water is passed through the corresponding water supply hose and the level of washing water, exiting the detergent supply device 50 and filling the tub 10 via the bellows tube 44, is detected. In doing so, the water from the external source is supplied via one or more of the water supply valves 42a, 42b, 42c, and 42d to enter the detergent box 54, to be therein mixed with the stored agents, and to exit the detergent box and supplied as washing water to the tub 10 via the bellows tube 44. After the first predetermined time x has elapsed, the water supply valve 42a is turned off for the duration of the second predetermined time y. In doing so, the detergent contained in the detergent supply device 50 is dissolved in the water to be slowly drained via the bellows tube 44. Hence, a fixed quantity of the detergent can be supplied to the tub without flooding. By detecting the level of the washing water in the tub using the water level detector 98 and the controller 99, the washer repeats the above water supply and cut-off steps by controllably turning on and off the water supply valves until the detected water level reaches a predetermined water level (S12). Once the detected level of washing water supplied to the tub reaches the predetermined water level, the turning on and off of the water supply valve is terminated, whereupon the washer performs a wash or rinse cycle.

The water supply control method according to the present invention will be explained in detail for each agent species, i.e., a powder detergent, a liquid detergent, a bleach, and a softening agent.

Preliminary And Main Detergent Water Supply Modes

With a powder detergent stored in one or both of the main and preliminary detergent compartments 58 and 62 (without loading the first and second liquid detergent receptacles 82 and 92), laundry placed in the drum, a wash cycle selected, and the washer actuated, the water supply for washing the laundry is initiated. Here, taking the preliminary detergent water supply mode as an example, the first cold water valve 42a is turned on to supply water to the preliminary detergent compartment 62 via the preliminary detergent water supply passage 74 and the preliminary detergent water supply holes 74b formed in the bottom panel 78 of the dispenser cover 70. The water thus draining into the preliminary detergent compartment 62 becomes mixed with the powder detergent, and the draining mixture proceeds to the rear of the preliminary detergent compartment, exits the open rear side of the detergent box 54 to enter the detergent box housing 52, and then enters the bellows 44 via the outlet 53 to be supplied to the tub and used for main washing.

In the preliminary detergent water supply mode, whereby the first cold water valve 42a is controlled according to the present invention by being firstly turned on during a third predetermined time (x−3) and then turned off during a fourth predetermined time (y+3), a controlled water supply is carried out by repetitiously turning the cold water valve on and off until the water level in the tub reaches the predetermined water level, whereupon the repetition is terminated. Each of the third and fourth predetermined times has a value set according to a volume of the preliminary detergent compartment 62, so that the intermittent application of a water supply from the above control of the first cold water valve 42a prevents the flooding of the detergent box area with a mixture of liquid detergent and water.

Thereafter, to perform a main washing with a liquid detergent after completion of a preliminary washing using liquid detergent, the first and second liquid detergent receptacles 82 and 92 are loaded in the main and preliminary detergent compartments 58 and 62, respectively, so that liquid detergent may be stored in either receptacle.

Second Liquid Detergent Water Supply Mode

With laundry placed in the drum, a wash cycle selected, and the washer actuated, the first cold water valve 42a is turned on to supply water to the preliminary detergent compartment 62 via the preliminary detergent water supply passage 74 and the preliminary detergent water supply holes 74b formed in the bottom panel 78 of the dispenser cover 70. The water in the second liquid detergent receptacle 92 is mixed with liquid detergent, and the mixture ascends via the outer liquid detergent siphon tube 96c of the second liquid detergent siphon cover 96 and then descends via the inner liquid detergent siphon tube 95 of the second liquid detergent receptacle 92 to drain into the preliminary detergent compartment 62. The draining mixture proceeds to the rear of the preliminary detergent compartment 62, exits the open rear side of the detergent box 54 to enter the detergent box housing 52, and then enters the bellows 44 via the outlet 53 to be supplied to the tub and used for preliminary washing.

In the second liquid detergent water supply mode, whereby the first cold water valve 42a is controlled according to the present invention by being firstly turned on during a fifth predetermined time (x−1) and then turned off during a sixth predetermined time (y+1), a controlled water supply is carried out by repetitiously turning the cold water valve on and off until the water level in the tub reaches the predetermined water level, whereupon the repetition is terminated. Each of the fifth and sixth predetermined times has a value set according to a volume of the second liquid detergent receptacle 92, so that the intermittent application of a water supply from the above control of the first cold water valve 42a prevents the flooding of the detergent box area with a mixture of liquid detergent and water.

First Liquid Detergent Water Supply Mode

On the other hand, the second cold water valve 42b is turned on to supply water to the main detergent compartment 58 via the main detergent water supply passage 73 and the main detergent water supply holes 73b formed in the bottom panel 78 of the dispenser cover 70. The water in the first liquid detergent receptacle 82 is mixed with liquid detergent, and the mixture ascends via the outer liquid detergent siphon tube 86c of the first liquid detergent siphon cover 86 and then descends via the inner liquid detergent siphon tube 85 of the first liquid detergent receptacle 82 to drain into the main detergent compartment 58. The draining mixture proceeds to the rear of the main detergent compartment 58, exits the open rear side of the detergent box 54 to enter the detergent box housing 52, and then enters the bellows 44 via the outlet 53 to be supplied to the tub and used for main washing.

In the first liquid detergent water supply mode, the second cold water valve 42b is controlled according to the present invention by being firstly turned on during a seventh predetermined time (x−1) and then turned off during a eighth predetermined time (y+1), a controlled water supply is carried out by repetitiously turning the cold water valve on and off until the water level in the tub reaches the predetermined water level, whereupon the repetition is terminated. Each of the seventh and eighth predetermined times has a value set according to a volume of the first liquid detergent receptacle 82, so that the intermittent application of a water supply from the above control of the second cold water valve 42b prevents the flooding of the detergent box area with a mixture of liquid detergent and water.

After completion of the main washing, the washer is drained and a subsequent cycle such as rinsing or dewatering cycle is carried out. If a rinsing cycle is to be performed, the second cold water valve 42b is turned on to supply the tub with a predetermined level of fresh water via the dispenser cover 70, the main detergent compartment 58, the detergent box housing 52, and the bellows tube 44.

Bleach Water Supply Mode

With bleach stored in the bleach compartment 59 and the washer actuated to perform a main washing cycle, the third cold water valve 42c is turned on to supply water to the main detergent compartment 58 via the bleach water supply passage 75 and the bleach water supply hole 75b formed in the bottom panel 78 of the dispenser cover 70. The water mixed with the bleach contained in the bleach compartment 59 drains into the main detergent compartment 58 by ascending via the outer bleach siphon tube 60c of the bleach siphon cover 60 and then descending via the inner bleach siphon tube 59a of the bleach compartment to settle in the bottom of the main detergent compartment. The mixture is then supplied from the main detergent compartment 58 to the tub.

In the bleach water supply mode, whereby the third cold water valve 42c is controlled according to the present invention by being firstly turned on during a ninth predetermined time (x−1) and then turned off during a tenth predetermined time (y+1), a controlled water supply is carried out by repetitiously turning the cold water valve on and off until the water level in the tub reaches the predetermined water level, whereupon the repetition is terminated. Each of the ninth and tenth predetermined times has a value set according to a volume of the bleach compartment 59, so that the intermittent application of a water supply from the above control of the third cold water valve 42c prevents the flooding of the detergent box area with a mixture of bleach and water.

Softening Agent Water Supply Mode

With a softening agent stored in the softening agent compartment 63 and the washer actuated to perform a rinse cycle, the first and second cold water valves 42a and 42b are simultaneously turned on to supply water to the preliminary detergent compartment 62 via the softening agent water supply passage 76 and the softening agent water supply hole 76b formed in the bottom panel 78 of the dispenser cover 70. The supplied water is mixed with the softening agent contained in the softening agent compartment 63 and drains into the preliminary detergent compartment 62 by ascending via the outer softening agent siphon tube 64c of the softening agent siphon cover 64 and then descending via the inner softening agent siphon tube 63a of the softening agent compartment to settle in the bottom of the preliminary detergent compartment. The mixture is then supplied from the preliminary detergent compartment 62 to the tub.

In the softening agent water supply mode, whereby each of the cold water valves 42a and 42b are controlled according to the present invention by being firstly turned on during an eleventh predetermined time (x−4) and then turned off during a twelfth predetermined time (y+4), a controlled water supply is carried out by repetitiously turning the cold water valves on and off until the water level in the tub reaches the predetermined water level, whereupon the repetition is terminated. Each of the eleventh and twelfth predetermined times has a value set according to a volume of the softening agent compartment 63, so that the intermittent application of a water supply from the above control of the first and second cold water valves 42a and 42b prevents the flooding of the detergent box area with a mixture of softening agent and water.

In the water supply control method according to the present invention, a water supply valve is firstly turned on during the first predetermined time and is then turned off during the second predetermined time, which is repeated to produce an intermittent water supply to the tub. The present invention prevents a flooding of the detergent box area with washing water to maintain a clean interior environment and enables the detergent to be introduced to the supplied water in a fixed quantity.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

1. A method of supplying water in an automatic washer having at least one water supply valve for supplying the water to a tub via a detergent box and a water level detector for detecting a level of the water suppled to the tub, the method comprising:
turning on the at least one water supply valve during a first predetermined time; and
turning off, after elapse of the first predetermined time, the at least one water supply valve during a second predetermined time.

2. The method as claimed in claim 1, further comprising:
repeating said turning on and turning off until the level of the water supplied to the tub reaches a predetermined water level.

3. The method as claimed in claim 1, wherein the first predetermined time is proportional to a volume of the detergent box.

4. The method as claimed in claim 1, wherein the second predetermined time is inversely proportional to a volume of the detergent box.

5. The water supply control method of claim 1, wherein the detergent box comprises a plurality of compartments for respectively storing agents to be mixed with the supplied water and wherein the first and second predetermined times are set to have values corresponding to each compartment.

6. The method as claimed in claim 5, wherein the values of the first and second predetermined times are based on a configuration of the detergent box.

7. The method as claimed in claim 5, wherein the values of the first and second predetermined times are based on a configuration of each compartment of the detergent box.

8. The method as claimed in claim 5, wherein the values of the first and second predetermined times are based on a volume of each compartment of the detergent box.

9. The method as claimed in claim 5, wherein the first predetermined time is proportional to a volume of one of the plurality of compartments of the detergent box.

10. The method as claimed in claim 5, wherein the second predetermined time is inversely proportional to a volume of one of the plurality of compartments of the detergent box.

11. The method as claimed in claim 1, wherein said turning on and said turning off of the at least one water supply valve is performed according to one of a plurality of water supply modes.

12. The method as claimed in claim 11, wherein the first and second predetermined times are set to have values corresponding to each mode.

13. The method as claimed in claim 11, wherein the plurality of water supply modes includes a preliminary detergent water supply mode, a main detergent water supply mode, a first liquid detergent water supply mode, a second liquid detergent water supply mode, a softening agent water supply mode, and a bleach water supply mode.

14. The method as claimed in claim 13, wherein, in the preliminary detergent water supply mode, water is supplied to a preliminary detergent compartment of the detergent box via a first predetermined valve of the at least one water supply valve.

15. The method as claimed in claim 13, wherein, in the main detergent water supply mode, water is supplied to a main detergent compartment of the detergent box via a second predetermined valve of the at least one water supply valve.

16. The method as claimed in claim 13, wherein, in the first liquid detergent water supply mode, water is supplied to a main detergent compartment of the detergent box via a second predetermined valve of the at least one water supply valve.

17. The method as claimed in claim 13, wherein, in the second liquid detergent water supply mode, water is supplied to a main detergent compartment of the detergent box via a first predetermined valve of the at least one water supply valve.

18. The method as claimed in claim 13, wherein, in the preliminary detergent water supply mode, water is supplied to a preliminary detergent compartment of the detergent box.

19. The method as claimed in claim 18, wherein, in the second liquid detergent water supply mode, water is supplied to a second liquid detergent receptacle loaded in the preliminary detergent compartment.

20. The method as claimed in claim 13, wherein, in the main detergent water supply mode, water is supplied to a main detergent compartment of the detergent box.

21. The method as claimed in claim 20, wherein, in the first liquid detergent water supply mode, water is supplied to a first liquid detergent receptacle loaded in the main detergent compartment.

22. The method as claimed in claim 13, wherein, in the bleach water supply mode, water is supplied to a bleach compartment of the detergent box.

23. The method as claimed in claim 13, wherein, in the softening agent water supply mode, water is supplied to a softening agent compartment of the detergent box.

24. The method as claimed in claim 13, wherein the first and second predetermined times have first values set according to the preliminary detergent water supply mode and have second values set according to the main detergent water supply mode.

25. The method as claimed in claim 13, wherein the first and second predetermined times have first values set according to the first liquid detergent water supply mode and have second values set according to the second liquid detergent water supply mode.

26. The method as claimed in claim 13, wherein the first and second predetermined times have first values set according to the bleach water supply mode and have second values set according to the softening agent water supply mode.
